(19) United States
(12) Patent Application Publication
(10) Pub. No.: US 2022/0323886 A1
(43) Pub. Date: Oct. 13, 2022

(54) Filtration System and Method

(71) Applicant: Chevron U.S.A. Inc., San Ramon, CA (US)

(72) Inventor: James Mitchell Knight, Gautier, MS (US)

(21) Appl. No.: 17/225,391

(22) Filed: Apr. 8, 2021

(51) Int. Cl. B01D 29/52; B01D 29/68

(52) U.S. Cl. CPC B01D 29/52; B01D 29/682; B01D 29/668

(57) ABSTRACT

A filter unit includes an upper diverter chamber having a feed outlet, a backwash inlet, and an upper diverter tube in fluid communication with the backwash inlet. The filter unit also includes a lower diverter chamber comprising a feed inlet, a backwash outlet, and a lower diverter tube in fluid communication with the backwash outlet. A diverter motor is disposed between the upper diverter chamber and the lower diverter chamber. The diverter motor is coupled to a drive shaft. An upper end of the drive shaft is coupled to the upper diverter tube and a lower end of the drive shaft is coupled to the lower diverter tube. Filter housings are in fluid communication with the upper diverter chamber and the lower diverter chamber.

### TECHNICAL FIELD

Embodiments of the technology relate generally to a filtration system for a hydrocarbon refinery.

### BACKGROUND

Petroleum refineries process hydrocarbons into hydrocarbon components that can be used in a variety of applications. The refineries can include catalytic reactors that process the petroleum. Filtration systems are used in conjunction with the catalytic reactors to filter the hydrocarbon components. Efficient operation of the filtration system improves the overall efficiency of the refinery. Therefore, improvements to filtration systems can be beneficial to refinery operations. The following disclosure addresses one or more shortcomings in the prior art and describes additional advantages of the disclosed methods and apparatus.

### SUMMARY

The present disclosure is generally directed to an improved filtration system. In one example embodiment, the present disclosure is directed to a filtration system comprising a piping network and an array of filter units. The piping network can comprise a feed inlet pipe comprising a feed inlet split joint, a feed outlet pipe comprising a feed outlet split joint, a backwash inlet pipe comprising a backwash inlet split joint, and a backwash outlet pipe comprising a backwash outlet split joint. The filtration system can further comprise a first filter unit and a second filter unit, wherein the first filter unit and the second filter unit are in fluid communication with and equidistant from each of the feed inlet split joint, the feed outlet split joint, the backwash inlet split joint, and the backwash outlet split joint. The first filter unit and the second filter unit can each comprise an upper diverter chamber, a lower diverter chamber, a diverter motor, and a plurality of filter housings. The upper diverter chamber can comprise a feed outlet, a backwash inlet, and an upper diverter tube in fluid communication with the backwash inlet. The lower diverter chamber can comprise a feed inlet, a backwash outlet, and a lower diverter tube in fluid communication with the backwash outlet. The diverter motor can be disposed between the upper diverter chamber and the lower diverter chamber and coupled to a drive shaft. An upper end of the drive shaft can be coupled to the upper diverter tube and a lower end of the drive shaft can be coupled to the lower diverter tube. The plurality of filter housings can be in fluid communication with the upper diverter chamber and the lower diverter chamber.

In the foregoing filtration system, the backwash inlet can be disposed at a top wall of the upper diverter chamber.

In the foregoing filtration system, the upper diverter tube and the lower diverter tube can be rotated simultaneously by the drive shaft coupled to the diverter motor.

In the foregoing filtration system, the upper diverter tube and the lower diverter tube can be rotated simultaneously between a neutral position, a first fluid communication position with a first filter housing of the plurality of filter housings, and a second fluid communication position with a second filter housing.

In the foregoing filtration system, the upper diverter tube and the lower diverter tube each can have an elbow shape.

In the foregoing filtration system, a backwash inlet valve can control flow of backwash into the backwash inlet.

In the foregoing filtration system, the diverter motor can be attached to a support located between the upper diverter chamber and the lower diverter chamber.

In the foregoing filtration system, the diverter motor can be attached to the upper diverter chamber by a support.

In the foregoing filtration system, the diverter motor can be attached to the lower diverter chamber by a support.

In the foregoing filtration system, the backwash inlet can be disposed at a top of the upper diverter chamber; and the upper diverter tube and the lower diverter tube can be rotated simultaneously by the drive shaft coupled to the diverter motor.

In another example embodiment, the present disclosure can be directed to a filter unit of a filtration system. The filter unit can comprise an upper diverter chamber, a lower diverter chamber, a diverter motor, and a plurality of filter housings. The upper diverter chamber can comprise a feed outlet, a backwash inlet, and an upper diverter tube in fluid communication with the backwash inlet. The lower diverter chamber can comprise a feed inlet, a backwash outlet, and a lower diverter tube in fluid communication with the backwash outlet. The diverter motor can be disposed between the upper diverter chamber and the lower diverter chamber and coupled to a drive shaft. An upper end of the drive shaft can be coupled to the upper diverter tube and a lower end of the drive shaft can be coupled to the lower diverter tube. The plurality of filter housings can be in fluid communication with the upper diverter chamber and the lower diverter chamber.

In the foregoing filter unit, the feed outlet can be configured to couple to a feed outlet pipe of a catalytic reactor, the feed inlet can be configured to couple to a feed inlet pipe of the catalytic reactor, the backwash inlet can be configured to couple to a backwash inlet pipe of the catalytic converter, and the backwash outlet can be configured to couple to a backwash outlet pipe of the catalytic converter.

In the foregoing filter unit, the backwash inlet can be disposed at a top wall of the upper diverter chamber.

In the foregoing filter unit, the upper diverter tube and the lower diverter tube can be rotated simultaneously by the drive shaft coupled to the diverter motor.

In the foregoing filter unit, the upper diverter tube and the lower diverter tube can be rotated simultaneously between a neutral position, a first fluid communication position with a first filter housing of the plurality of filter housings, and a second fluid communication position with a second filter housing.

In the foregoing filter unit, the upper diverter tube and the lower diverter tube each can have an elbow shape.

In the foregoing filter unit, a backwash inlet valve can control flow of backwash into the backwash inlet.

In the foregoing filter unit, the diverter motor can be attached to a support located between the upper diverter chamber and the lower diverter chamber.

In the foregoing filter unit, the diverter motor can be attached to the upper diverter chamber by a support.

In the foregoing filter unit, the diverter motor can be attached to the lower diverter chamber by a support.

The foregoing embodiments are non-limiting examples and other aspects and embodiments will be described herein. The foregoing summary is provided to introduce various concepts in a simplified form that are further described below in the detailed description. This summary is not intended to identify required or essential features of the claimed subject matter nor is the summary intended to limit the scope of the claimed subject matter.

### BRIEF DESCRIPTION OF THE DRAWINGS

The accompanying drawings illustrate only example embodiments of a filtration system and therefore are not to be considered limiting of the scope of this disclosure. The principles illustrated in the example embodiments of the drawings can be applied to alternate methods and apparatus for a filtration system. Additionally, the elements and features shown in the drawings are not necessarily to scale, emphasis instead being placed upon clearly illustrating the principles of the example embodiments. Certain dimensions or positions may be exaggerated to help visually convey such principles.

FIG. 1 is a perspective view of a portion of a filtration system as known in the prior art.

FIG. 2 is a top schematic view of the filtration system of FIG. 1 as known in the prior art.

FIG. 3 is a perspective view of a filter unit as known in the prior art.

FIG. 4 is a perspective view of the interior of a lower diverter chamber of the filter unit of FIG. 3 as known in the prior art.

FIG. 5 is a cross-sectional view of a filter unit in accordance with an example embodiment of the disclosure.

FIG. 6 is a top schematic view of a filtration system in accordance with an example embodiment of the disclosure.

### DETAILED DESCRIPTION OF EXAMPLE EMBODIMENTS

The example embodiments discussed herein are directed to methods and apparatus for a filtration system. The example embodiments described herein can provide improvements to filtration systems used in petroleum refineries. As will be described further in the following examples, the methods and apparatus described herein improve upon prior art approaches to filtration systems. The techniques described herein provide for an optimized and more efficient filtration system. The techniques described herein eliminate undesirable components and conditions when compared to prior art approaches.

In the following paragraphs, particular embodiments will be described in further detail by way of example with reference to the drawings. In the description, well-known components, methods, and/or processing techniques are omitted or briefly described. Furthermore, reference to various feature(s) of the embodiments is not to suggest that all embodiments must include the referenced feature(s).

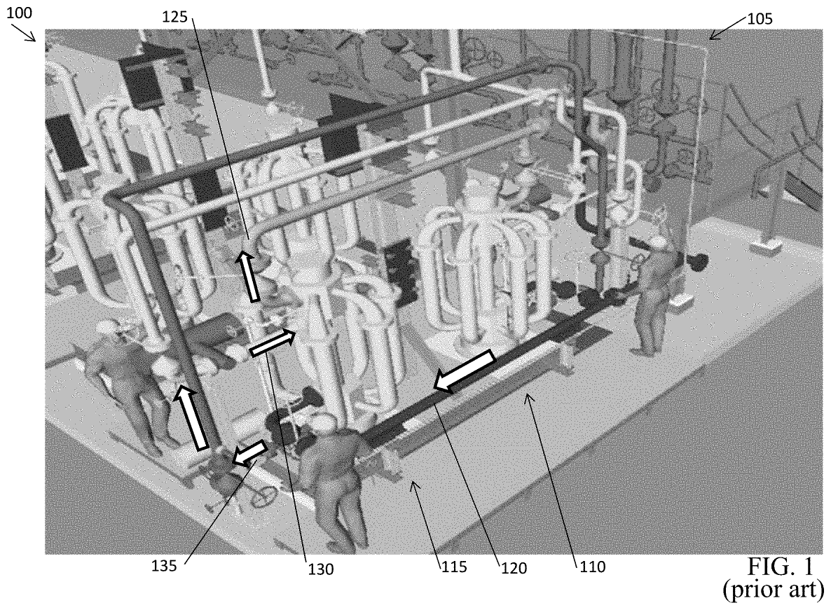

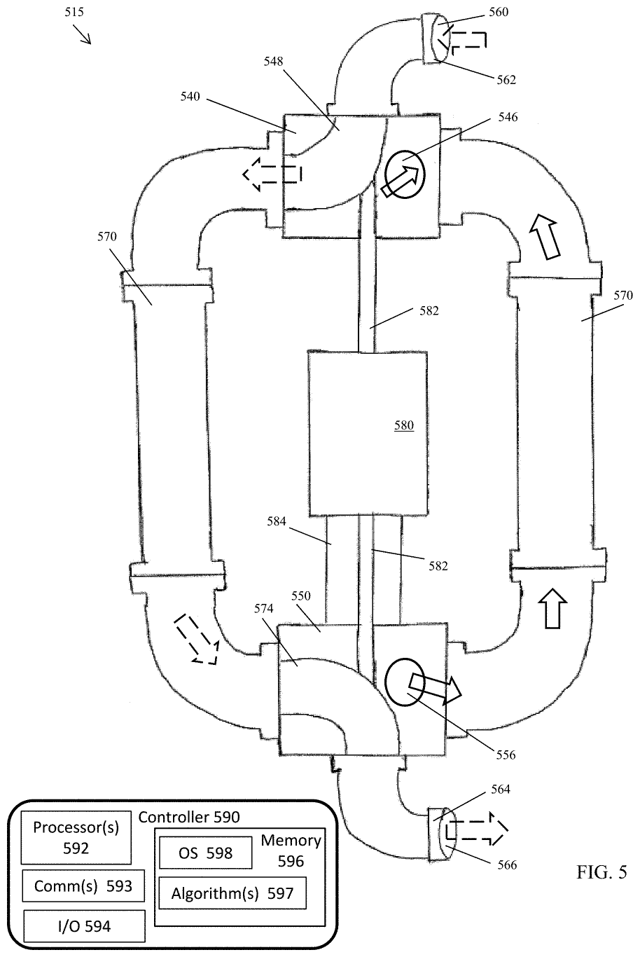

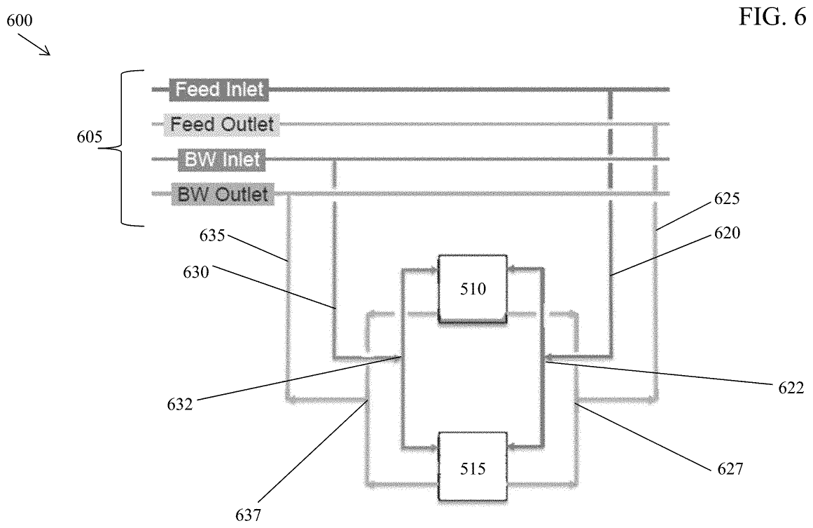

FIGS. 1, 2, 3, and 4 illustrate a filtration system as known in the prior art. FIGS. 5 and 6 illustrate a novel filtration system in accordance with the example embodiments of the present disclosure.

Referring now to FIG. 1, a top perspective view of a filtration system 100 as known in the prior art is illustrated. The filtration system can be used in a refinery for filtering hydrocarbon components (also referred to herein as a hydrocarbon feed). For example, the filtration system can be coupled to a catalytic reactor and can be used to filter hydrocarbon components such as heavy vacuum gas oil. The filtration system comprises a bank of filter units including filter unit 110 and filter unit 115. Piping headers 105 comprise a series of connecting pipes that couple the filtration system to one or more catalytic reactors. Connecting the piping headers 105 to the filter units of the filtration system are a series of inlet and outlet pipes. Specifically, a feed inlet pipe 120 supplies a hydrocarbon component from a catalytic reactor to filter units 110 and 115. After the hydrocarbon component is filtered in the filter units, it is transported to downstream assemblies of the refinery such as hydroprocessing reactors by feed outlet pipe 125. The inlet and outlet pipes of the filtration system also include a backwash inlet pipe 130 and a backwash outlet pipe 135. The backwash inlet pipe 130 supplies a backwash fluid, typically a previously filtered hydrocarbon component, to the filter units for the purpose of cleaning unwanted particle buildup from the filter media located within the filter units. After passing through the filter units, the backwash outlet pipe 135 transports the backwash fluid to a downstream assembly of the refinery such as a feed tank or off-test crude tank.

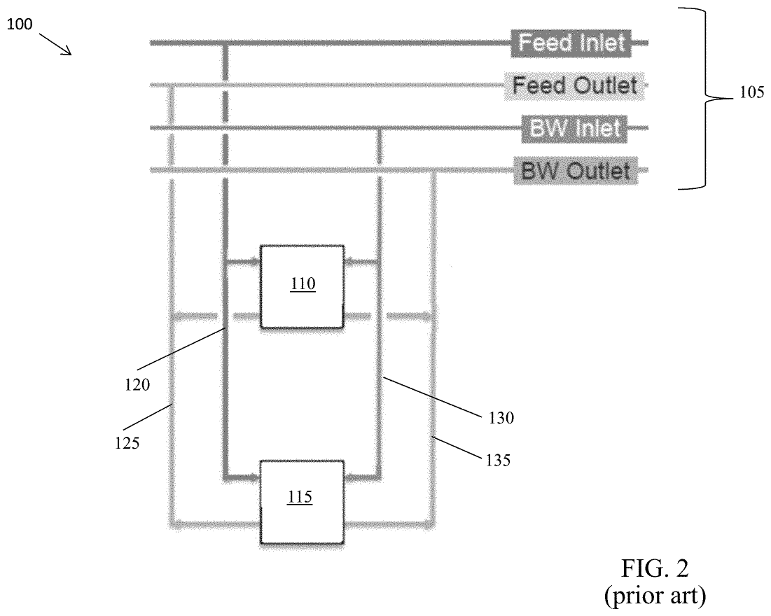

FIG. 2 provides a top view schematic of the filtration system 100 described in connection with FIG. 1. As shown in FIG. 2, the feed inlet pipe 120, feed outlet pipe 125, backwash inlet pipe 130, and backwash outlet pipe 135 provide connections between the piping headers 105 and filter units 110 and 115. The feed inlet pipe 120 supplies a hydrocarbon component from a catalytic reactor to filter units 110 and 115. After the hydrocarbon component flows through the filter unit, it is carried away by feed outlet pipe 125 to a downstream refinery assembly. When the filter media of the filter units require cleaning, the backwash inlet pipe 130 supplies a backwash fluid, typically a previously filtered hydrocarbon component, to the filter units 110 and 115. The backwash fluid flows through the filter units 110 and 115 in a direction opposite to the flow of the hydrocarbon component that is being filtered. The backwash fluid cleans particles from the filter media in the filter units and then flows via the backwash outlet pipe 135 to a downstream refinery assembly.

As illustrated in FIG. 2, the inlet and outlet pipe connections to the filter units 110 and 115 are asymmetrical. The asymmetrical pipe connections result in a greater pressure in filter unit 115 than in filter unit 110. The differences in pressure of the hydrocarbon component flow and the backwash fluid at the filter units 115 and 110 creates different flow characteristics at each filter unit which complicates maintenance of the filtration system 100 and reduces efficiency. For example, the difference in pressure between the filter units can result in one filter unit requiring maintenance sooner than the other filter unit. A system that reduces or eliminates the pressure differential between filter units 110 and 115 would be advantageous in simplifying maintenance.

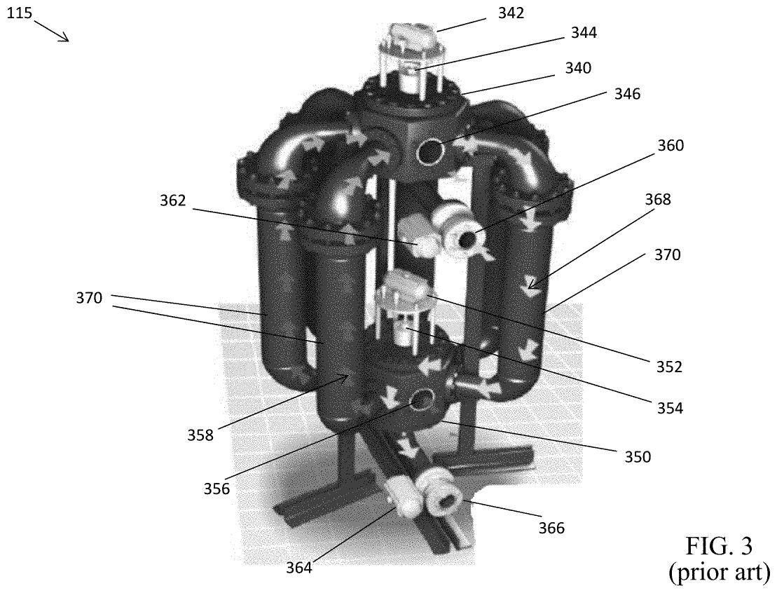

Referring now to FIG. 3, a perspective view of a filter unit 115 as known in the prior art is shown. It should be understood that filter unit 110 and filter unit 115 are substantially identical such that the description of the components of filter unit 115 also applies to the components of filter unit 110. Filter unit 115 includes six cylindrical filter housings connected at the top of the filter unit 115 to an upper diverter chamber 340 and connected at the bottom of the filter unit 115 to a lower diverter chamber 350. The cylindrical filter housings contain filter media that filters particles from hydrocarbon fluids as they flow through the filter media.

The lower diverter chamber 350 comprises a side wall having a generally cylindrical shape enclosed by a top wall and a bottom wall. The side wall of the lower diverter chamber 350 includes a feed inlet 356 which couples to feed inlet pipe 120. The bottom wall of the lower diverter chamber 350 includes backwash outlet 366 which couples to backwash outlet pipe 135. The backwash outlet 366 can include a valve controlled by a lower valve actuator 364.

The upper diverter chamber 340 comprises a side wall having a generally cylindrical shape enclosed by a top wall and a bottom wall. The side wall of the upper diverter chamber 340 includes a feed outlet 346 which couples to a feed outlet pipe 125. The bottom wall of the upper diverter chamber 340 includes backwash inlet 360 which couples to backwash inlet pipe 130. The backwash inlet 360 can include a valve controlled by an upper valve actuator 362. The upper valve actuator 362 and the lower valve actuator 364 can be air operated or operated electronically by a controller.

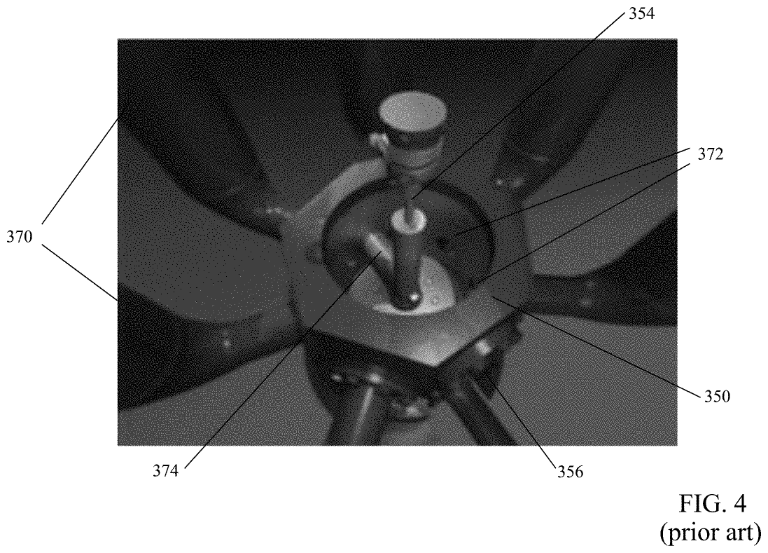

FIG. 4 illustrates the interior of the lower diverter chamber 350. It should be understood that the upper diverter chamber 340 is substantially identical to the lower diverter chamber 350. Accordingly, the following discussion of lower diverter chamber 350 applies to analogous components of the upper diverter chamber 340.

Referencing FIGS. 3 and 4, the lower diverter chamber 350 has a lower actuator 352 and a lower motor 354 mounted on the top wall of the lower diverter chamber 350. The lower actuator 352 and lower motor 354 control a lower diverter elbow 374 that rotates within the lower diverter chamber 350. As can be seen along the interior side wall of the lower diverter chamber 350, each filter housing 370 has a respective filter housing port 372. When the lower diverter elbow 374 is in a neutral position it does not align with any of the filter housing ports 372. When the lower diverter elbow 374 is in the neutral position, a hydrocarbon component flows into the lower diverter chamber 350 via feed inlet 356. The feed inlet is connected to feed inlet pipe 120. As the hydrocarbon component flows into the lower diverter chamber 350 it then flows into each of the filter housing ports 372 and through each filter housing 370 where it is filtered by filter media. After passing in an upward direction through each filter housing 370, the hydrocarbon component flows into the upper diverter chamber 340 and exits through the feed outlet 346. The feed outlet 346 is coupled to feed outlet pipe 125. The direction of flow of the hydrocarbon feed that is to be filtered through filter unit 115 is illustrated by the darker shaded arrows in FIG. 3.

When a filter housing 370 is identified as requiring backwashing to clean particles from the filter media, a backwash fluid flows through the filter unit 115 in a direction opposite to the flow of the hydrocarbon component. Specifically, the lower actuator 352 and the lower motor 354 rotate the lower diverter elbow 374 so that it aligns with the filter housing port 372 of the identified filter housing 370 that requires cleaning. The upper diverter chamber 340 has an upper actuator 342 and an upper motor 344 mounted on the top wall of the upper diverter chamber 340 and an upper diverter elbow that rotates within the upper diverter chamber 340 in a similar manner to the lower diverter elbow 374. The upper actuator 342 and the upper motor 344 align the upper diverter elbow with the filter housing port of the identified filter housing 370 that requires cleaning. Once the identified filter housing 370 is isolated from the hydrocarbon component flow by aligning the lower diverter elbow 374 and a similar upper diverter elbow with the filter housing ports, the backwash fluid flows into the backwash inlet 360 through the upper diverter elbow, through the identified filter housing 370, through the lower diverter elbow 374, and out through the backwash outlet 366. The direction of flow of the backwash fluid through the filter unit 115 is illustrated by the lighter shaded arrows in FIG. 3.

One problem with the prior art filter unit illustrated in FIGS. 3 and 4 is that the upper diverter elbow and the lower diverter elbow are independently controlled by separate actuators and motors. Because separate actuators and motors are controlling each of the diverter elbows, the diverter elbows can become unsynchronized. When the diverter elbows become unsynchronized, they are not aligned over corresponding filter housing ports of the same filter housing and therefore they fail to isolate the filter housing from the other filter housings of the filter unit for a backwash. The position of each diverter elbow is detected by a sensor switch located on each diverter chamber. When the sensor switches detect that the upper diverter elbow and the lower diverter elbow are misaligned, a fault signal causes the upper diverter elbow and lower diverter elbow to rotate to the neutral position (also called the home position) in each diverter chamber. In some cases the actuators are unable to locate the neutral position for one or both of the diverters causing them to continuously cycle. These asynchronous instances that trigger a fault condition requiring a correction to the system result in inefficiencies for the entire filtration system. Accordingly, an improvement to the filter unit that avoids the asynchronous instances would be beneficial.

Referring now to FIG. 5, an improved filter unit 515 is illustrated in accordance with the example embodiments of the present disclosure. The example filter unit 515 is shown as a cross section in FIG. 5 for illustrative purposes. As will become clear from the following description, filter unit 515 provides advantages over the prior art filter unit described in connection with FIGS. 1-4.

Example filter unit 515 includes a plurality of cylindrical filter housings 570, 571 connected at the top of the filter unit 515 to an upper diverter chamber 540 and connected at the bottom of the filter unit 515 to a lower diverter chamber 550. Only two filter housings 570, 571 are shown in FIG. 5 for clarity, however, it should be understood that the filter unit can include more than two filter housings. The cylindrical filter housings 570, 571 contain filter media that filters particles from hydrocarbon fluids as they flow through the filter media.

The lower diverter chamber 550 comprises a side wall having a generally cylindrical shape enclosed by a top wall and a bottom wall. The back portion of the side wall of the lower diverter chamber 550 includes a feed inlet 556 which couples to a feed inlet pipe. The bottom wall of the lower diverter chamber 350 includes backwash outlet 566 which couples to a backwash outlet pipe. The backwash outlet 566 can include a valve controlled by a lower valve actuator 564.

The upper diverter chamber 540 comprises a side wall having a generally cylindrical shape enclosed by a top wall and a bottom wall. The back portion of the side wall of the upper diverter chamber 540 includes a feed outlet 546 which couples to a feed outlet pipe. The top wall of the upper diverter chamber 340 includes backwash inlet 560 which couples to a backwash inlet pipe. The backwash inlet 560 can include a valve controlled by an upper valve actuator 562. The upper valve actuator 562 and the lower valve actuator 564 can be operated electronically by controller 590.

The example filter unit 515 also comprises a motor 580 disposed between the upper diverter chamber 540 and the lower diverter chamber 550. The motor 580 is positioned on a support 584 attached to the top wall of the lower diverter chamber 550. In alternate embodiments, the motor can be suspended from a support that extends down from the upper diverter chamber 540. In yet other embodiments, the motor can be secured by a support extending down from the upper diverter chamber 540 and another support extending up from the lower diverter chamber 550. The motor drives a single drive shaft 582 that extends upward into the upper diverter chamber 540 and that extends downward into the lower diverter chamber 550.

Unlike the prior art filter units, the example filter unit 515 positions the backwash inlet 560 on the top wall of the upper diverter chamber 540. Positioning the backwash inlet 560 on the top wall provides clearance for the drive shaft 582 to extend up from the motor 580 and through the bottom wall of the diverter chamber 540. An upper portion of the drive shaft 582 is coupled to upper diverter elbow 548 located within the upper diverter chamber 540. The drive shaft 582 turns upper diverter elbow 548 in a rotational path about a longitudinal axis extending through the length of the drive shaft 582 and up through the upper diverter chamber 540. The upper diverter chamber 540 includes a plurality of filter housing ports located along the cylindrical side wall of the upper diverter chamber 540, wherein each filter housing port provides fluid communication to a top portion of a filter housing, such as filter housings 570, 571.

A lower portion of the drive shaft 582 extends downward from the motor 580 and passes through the top wall of the lower diverter chamber 550. The lower portion of the drive shaft 582 is coupled to lower diverter elbow 574 located within the lower diverter chamber 550. The drive shaft 582 turns the lower diverter elbow 574 in a rotational path about a longitudinal axis extending through the length of the drive shaft 582 and down through the lower diverter chamber 550. The lower diverter chamber 550 includes a plurality of filter housing ports located along the cylindrical side wall of the lower diverter chamber 550, wherein each filter housing port provides fluid communication to a bottom portion of a filter housing, such as filter housings 570, 571.

The solid arrows shown in FIG. 5 illustrate the direction of flow of the hydrocarbon component that is to be filtered through the filter unit 515. Specifically, the hydrocarbon component is fed by a feed inlet pipe to the feed inlet 556 in the lower diverter chamber 550. When the lower diverter elbow 574 is in the neutral position, it does not cover any of the filter housing ports along the cylindrical side wall of the lower diverter chamber 550. Accordingly, the hydrocarbon component flows from the lower diverter chamber 550 through the filter housing ports and into each of the filter housings. As illustrated by the solid arrows in the filter housing 570 of FIG. 5, the hydrocarbon component flows upward through the filter media within the filter housing 570 and empties into the upper diverter chamber 540. The filtered hydrocarbon component then exits the upper diverter chamber 540 through the feed outlet 546 where it flows into a feed outlet pipe.

Pressure sensors located in fluid communication with the filter housings can determine when the pressure differential in the flow of the hydrocarbon component across the filter media of a filter housing exceeds a predetermined threshold. Such a change in the pressure differential indicates an excessive accumulation of particles on the filter media. Controller 590 can receive information from sensors regarding the status of the filter unit 515 and can control various actions in connection with the filter unit 515. For example, when controller 590 detects an excessive pressure differential across a filter media of filter housing 571 of FIG. 5, the controller 590 can identify filter housing 571 as requiring a backwash to remove the accumulation of particles on the filter media.

A backwash involves directing a backwash fluid through a filter housing in a direction opposite to that of the hydrocarbon component flow illustrated by the solid arrows in FIG. 5. Specifically, the broken arrows in FIG. 5 illustrate the direction of flow of the backwash fluid through the filter unit 515. Controller 590 can engage upper valve actuator 562 to open the valve at the backwash inlet 560 so that a backwash fluid from a backwash inlet pipe flows into the backwash inlet 560. Controller 590 further engages motor 580 to turn drive shaft 582 to adjust the positions of the upper diverter elbow 548 and the lower diverter elbow 574. Each diverter elbow comprises an elbow shaped tube that directs the flow of backwash fluid into a selected filter housing port. Initially, the diverter elbows can be located at a neutral position between two filter housing ports so that a hydrocarbon component can flow into each of the unobstructed filter housing ports. Referencing the example shown in FIG. 5, when the controller 590 identifies filter housing 571 as requiring a backwash, the controller 590 engages the motor to turn the drive shaft 582 thereby turning both diverter elbows so that they are aligned with filter housing ports in the upper and lower diverter chambers that correspond with filter housing 571.

As shown in FIG. 5, the backwash fluid flows from a backwash inlet pipe 130, through backwash inlet 560, through upper diverter elbow 548, through the aligned upper filter housing port, and into the filter housing 571. As indicated by the broken arrows of FIG. 5, the backwash fluid flows through filter media thereby removing accumulated particles and exits the filter housing 571 through a filter housing port in the lower diverter chamber 550. The lower diverter elbow 574 is aligned with the filter housing port in the lower diverter chamber 550 so that the backwash fluid with the particles passes through the lower diverter elbow 574 and exits via backwash outlet 566 to a backwash outlet pipe. The controller can control the flow exiting the backwash outlet 566 by engaging lower valve actuator 564 to open the valve within the backwash outlet 566. While the upper diverter elbow 548 and the lower diverter elbow 574 are aligned with the filter housing ports associated with filter housing 571, filter housing 571 is isolated from the hydrocarbon component that continues to flow through feed inlet 556, through the lower diverter chamber 550, through filter housing 570, through upper diverter chamber 540, and through feed outlet 546.

The arrangement of the motor 580, the drive shaft 582, and the backwash inlet 560 in the example filter unit 515 provides several advantages over the prior art. First, because a single motor 580 and drive shaft 582 control the rotation of both the upper diverter elbow 548 and the lower diverter elbow 574, the two elbows are always synchronized and aligned. Therefore, filter unit 515 avoids the problems encountered with filter unit 115 where the diverter elbows can become misaligned so that they do not isolate a single filter housing. Another advantage of filter unit 515 is that it eliminates components required in filter unit 115. Specifically, filter unit 515 simplifies the design of the filter unit by eliminating the need for a second motor and implementing a single drive shaft 582.

As referenced in connection with FIG. 5, the filter unit 515 is connected to a filtration system such as filtration system 600 shown in FIG. 6. FIG. 6 provides a top schematic view of an improved filtration system 600 as compared to the arrangement of filtration system 100 shown in FIG. 2. As explained previously, the arrangement of inlet pipes and outlet pipes in filtration system 100 of FIG. 2 are asymmetrical. The asymmetrical pipe connections result in a greater pressure in filter unit 115 than in filter unit 110. The differences in pressure of the hydrocarbon component flow and the backwash fluid at the filter units 115 and 110 creates different flow characteristics at each filter unit which complicates maintenance of the filtration system 100 and reduces efficiency.

In contrast, the arrangement of pipes in filtration system 600 shown in FIG. 6 minimizes pressure differentials between filter unit 510 and filter unit 515. The feed inlet pipe 620, feed outlet pipe 625, backwash inlet pipe 630, and backwash outlet pipe 635 provide connections between the piping headers 605 and filter units 510 and 515. The feed inlet pipe 620 supplies a hydrocarbon component from a catalytic reactor via a split joint 622 to filter units 510 and 515. The feed inlet pipe 620 connects to the feed inlet of each filter unit. After the hydrocarbon component flows through the filter unit, it is carried away by feed outlet pipe 625 which is also connected to the filter units by a split joint 627. The feed outlet pipe 625 connects to the feed outlet of each filter unit. The split joints 622 and 627 provide for equal lengths of the feed inlet pipe 620 and the feed outlet pipe 625 to and from the filter units 510 and 515. The equal lengths of inlet and outlet pipe assist in minimizing pressure differentials between the two filter units.

Similarly, the backwash inlet pipe 630 and the backwash outlet pipe 635 are connected to the filter units 510, 515 by respective split joints 632 and 637. The backwash inlet pipe 630 connects to the backwash inlet of the filter units. The backwash outlet pipe 635 connects to the backwash outlet of the filter units. The split joints 632 and 637 provide for equal lengths of the backwash inlet pipe 630 and the backwash outlet pipe 635 to and from the filter units 510 and 515. The equal lengths of the inlet and outlet pipe assist in minimizing pressure differentials between the two filter units. Accordingly, the filtration system 600 is an improvement over filtration system 100.

Referring again to FIG. 5, the controller 590 can automate and control the operation of the filter units 510, 515 and the filtration system 600. Controller 590 of FIG. 5 illustrates an example embodiment of a controller for operating a filtration system. The components of the controller 590, can include, but are not limited to, one or more hardware processors 592, a memory 596, one or more input/output devices 594, and one or more communication interfaces 593. A bus (not shown) can allow the various components of the controller 590 to communicate with one another. A bus can be one or more of any of several types of bus structures, including a memory bus or memory controller, a peripheral bus, an accelerated graphics port, and a processor or local bus using any of a variety of bus architectures. The components shown in FIG. 5 are not exhaustive, and in some embodiments, one or more of the components shown in FIG. 5 may not be included in an example system. Further, one or more components shown in FIG. 5 can be rearranged.

The one or more communication interfaces 593 can transmit and receive signals from sensors, actuators, and motors via signal transfer links. The signal transfer links can include wired and/or wireless signal transfer links that transmit and receive communications via known communication protocols.

In one or more example embodiments, the one or more hardware processors 592 execute software instructions stored in memory 596. The memory 596 includes one or more cache memories, main memory, and/or any other suitable type of memory. The memory 596 can be a persistent storage device (or set of devices) that stores software and data used to assist the controller 590 in communicating with the other components of the filtration system 600. In one or more example embodiments, the memory 590 can store an operating system 598, algorithms 597, and stored data. For example, an algorithm 597 can dictate when an operating cycle for the filtration system 600 is to be entered and how many cycles to run. Such algorithms 597 can be based on information received from sensors, from data entered by a user, or may be static variables that are programed into the controller 590. Stored data can be any data associated with a filtration system 600 (including any components thereof), any measurements taken by sensors, time measured by a timer, adjustments to an algorithm 597, threshold values, user preferences, default values, results of previously run or calculated algorithms 597, and/or any other suitable data.

The one or more hardware processors 592 of the controller 590 can execute the operating system 598, algorithms 597, software, and firmware in accordance with one or more example embodiments. Generally, software includes routines, programs, objects, components, data structures, and so forth that perform particular tasks or implement particular abstract data types. An implementation of these modules and techniques are stored on or transmitted across some form of computer readable media, such as the memory 596.

The hardware processors 592 can be an integrated circuit, a central processing unit, a multi-core processing chip, SoC, a multi-chip module including multiple multi-core processing chips, or other hardware processor in one or more example embodiments. The hardware processor 592 is known by other names, including but not limited to a computer processor, a microprocessor, and a multi-core processor. In alternate embodiments, the one or more hardware processors 592 can be replaced by other logic devices such as one or more field programmable gate arrays (FPGAs) or one or more insulated-gate bipolar transistors (IGBTs). Using FPGAs, IGBTs, and/or other similar devices known in the art allows the controller 590 (or portions thereof) to be programmable and function according to certain logic rules and thresholds without the use of a hardware processor.

The one or more I/O devices 594, such as a keyboard, display, or touch screen interface, allow a user to enter commands and information to the filtration system, and also allow information to be presented to the user and/or other components or devices.

For any figure shown and described herein, one or more of the components may be omitted, added, repeated, and/or substituted. Accordingly, embodiments shown in a particular figure should not be considered limited to the specific arrangements of components shown in such figure. Further, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure.

With respect to the example methods described herein, it should be understood that in alternate embodiments, certain steps of the methods may be performed in a different order, may be performed in parallel, or may be omitted. Moreover, in alternate embodiments additional steps may be added to the example methods described herein. Accordingly, the example methods provided herein should be viewed as illustrative and not limiting of the disclosure.

Referring generally to the examples herein, any components of the apparatus (e.g., components of the filter unit such as the backwash inlet and outlet and the drive shaft), described herein can be made from a single piece (e.g., as from a mold, injection mold, die cast, 3-D printing process, extrusion process, stamping process, or other prototype methods). In addition, or in the alternative, a component of the apparatus can be made from multiple pieces that are mechanically coupled to each other. In such a case, the multiple pieces can be mechanically coupled to each other using one or more of a number of coupling methods, including but not limited to epoxy, welding, fastening devices, compression fittings, mating threads, and slotted fittings. One or more pieces that are mechanically coupled to each other can be coupled to each other in one or more of a number of ways, including but not limited to couplings that are fixed, hinged, removeable, slidable, and threaded.

Terms such as “first”, “second”, “top”, “bottom”, “side”, “distal”, “proximal”, and “within” are used merely to distinguish one component (or part of a component or state of a component) from another. Such terms are not meant to denote a preference or a particular orientation, and are not meant to limit the embodiments described herein. In the example embodiments described herein, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The terms “a,” “an,” and “the” are intended to include plural alternatives, e.g., at least one. The terms “including”, “with”, and “having”, as used herein, are defined as comprising (i.e., open language), unless specified otherwise.

Although embodiments described herein are made with reference to example embodiments, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A filtration system comprising:
a piping network configured to couple to a catalytic reactor, the piping network comprising:
a feed inlet pipe comprising a feed inlet split joint,
a feed outlet pipe comprising a feed outlet split joint,
a backwash inlet pipe comprising a backwash inlet split joint, and
a backwash outlet pipe comprising a backwash outlet split joint,
a first filter unit; and
a second filter unit,
wherein the first filter unit and the second filter unit are in fluid communication with and equidistant from each of the feed inlet split joint, the feed outlet split joint, the backwash inlet split joint, and the backwash outlet split joint, and
wherein the first filter unit and the second filter unit each comprise:
an upper diverter chamber comprising a feed outlet, a backwash inlet, and an upper diverter tube in fluid communication with the backwash inlet,
a lower diverter chamber comprising a feed inlet, a backwash outlet, and a lower diverter tube in fluid communication with the backwash outlet,
a diverter motor disposed between the upper diverter chamber and the lower diverter chamber, the diverter motor coupled to a drive shaft, an upper end of the drive shaft coupled to the upper diverter tube and a lower end of the drive shaft coupled to the lower diverter tube, and
a plurality of filter housings in fluid communication with the upper diverter chamber and the lower diverter chamber.

2. The filtration system of claim 1, wherein the backwash inlet is disposed at a top wall of the upper diverter chamber.

3. The filtration system of claim 1, wherein the upper diverter tube and the lower diverter tube are rotated simultaneously by the drive shaft coupled to the diverter motor.

4. The filtration system of claim 1, wherein the upper diverter tube and the lower diverter tube are rotated simultaneously between a neutral position, a first fluid communication position with a first filter housing of the plurality of filter housings, and a second fluid communication position with a second filter housing.

5. The filtration system of claim 1, wherein the upper diverter tube and the lower diverter tube each have an elbow shape.

6. The filtration system of claim 1, wherein a backwash inlet valve controls flow of backwash into the backwash inlet.

7. The filtration system of claim 1, wherein the diverter motor is attached to a support located between the upper diverter chamber and the lower diverter chamber.

8. The filtration system of claim 1, wherein the diverter motor is attached to the upper diverter chamber by a support.

9. The filtration system of claim 1, wherein the diverter motor is attached to the lower diverter chamber by a support.

10. The filtration system of claim 1,
wherein the backwash inlet is disposed at a top of the upper diverter chamber; and
wherein the upper diverter tube and the lower diverter tube are rotated simultaneously by the drive shaft coupled to the diverter motor.

11. A filter unit comprising:
an upper diverter chamber comprising a feed outlet, a backwash inlet, and an upper diverter tube in fluid communication with the backwash inlet;
a lower diverter chamber comprising a feed inlet, a backwash outlet, and a lower diverter tube in fluid communication with the backwash outlet;
a diverter motor disposed between the upper diverter chamber and the lower diverter chamber, the diverter motor coupled to a drive shaft, an upper end of the drive shaft coupled to the upper diverter tube and a lower end of the drive shaft coupled to the lower diverter tube; and
a plurality of filter housings in fluid communication with the upper diverter chamber and the lower diverter chamber.

12. The filter unit of claim 11,
wherein the feed outlet is configured to couple to a feed outlet pipe of a catalytic reactor;
wherein the feed inlet is configured to couple to a feed inlet pipe of the catalytic reactor;
wherein the backwash inlet is configured to couple to a backwash inlet pipe of the catalytic converter; and
wherein the backwash outlet is configured to couple to a backwash outlet pipe of the catalytic converter.

13. The filter unit of claim 11, wherein the backwash inlet is disposed at a top wall of the upper diverter chamber.

14. The filter unit of claim 11, wherein the upper diverter tube and the lower diverter tube are rotated simultaneously by the drive shaft coupled to the diverter motor.

15. The filter unit of claim 11, wherein the upper diverter tube and the lower diverter tube are rotated between a neutral position, a first fluid communication position with a first filter housing of the plurality of filter housings, and a second fluid communication position with a second filter housing.

16. The filter unit of claim 11, wherein the upper diverter tube and the lower diverter tube each have an elbow shape.

17. The filter unit of claim 11, wherein a backwash inlet valve controls flow of backwash into the backwash inlet.

18. The filter unit of claim 11, wherein the diverter motor is attached to a support located between the upper diverter chamber and the lower diverter chamber.

19. The filter unit of claim 11, wherein the diverter motor is attached to the upper diverter chamber by a support.

20. The filter unit of claim 11, wherein the diverter motor is attached to the lower diverter chamber by a support.
